(19) United States
(12) Patent Application Publication
(10) Pub. No.: US 2026/0340971 A1
(43) Pub. Date: Oct. 29, 2026

(54) VIDEO PROCESSING SYSTEM, VIDEO PROCESSING METHOD, AND VIDEO PROCESSING APPARATUS

(71) Applicant: NEC Corporation, Minato-ku, Tokyo (JP)

(72) Inventors: Yasunori BABAZAKI, Tokyo (JP); Katsuhiko TAKAHASHI, Tokyo (JP); Jun PIAO, Tokyo (JP); Ryuhei ANDO, Tokyo (JP); Koichi NIHEI, Tokyo (JP); Florian BEYE, Tokyo (JP); Takanori IWAI, Tokyo (JP); Hayato ITSUMI, Tokyo (JP)

(73) Assignee: NEC Corporation, Minato-ku, Tokyo (JP)

(21) Appl. No.: 19/103,576

(22) PCT Filed: Aug. 30, 2022
(86) PCT No.: PCT/JP2022/032585

§ 371 Date: Feb. 13, 2025

(51) Int. Cl. G06V 10/25; G06F 3/01; G06T 7/00; G06V 40/20

(52) U.S. Cl. CPC G06V 10/25; G06F 3/013; G06T 7/0002; G06V 40/20; G06V 2201/07

(57) ABSTRACT

A video processing system (10) includes an image quality control unit (11) that controls image quality of a gaze region including a gaze target in a video input to a video processing system (10), a recognition unit (12) that performs recognition processing regarding an object included in the video in which the image quality of the gaze region is controlled by the image quality control unit (11), and an extraction unit (13) that extracts the gaze target included in the gaze region controlled by the image quality control unit (11) based on a temporal change in a recognition result of the recognition processing performed by the recognition unit (12).

### TECHNICAL FIELD

The present disclosure relates to a video processing system, a video processing method, and a video processing apparatus.

### BACKGROUND ART

A system that performs monitoring and the like by applying a detection technique and a recognition technique using machine learning to a video captured by a camera is being developed.

Patent Literature 1 is known as a related technique. Patent Literature 1 discloses a technique which, in a monitoring camera that transmits a captured video via a network, predicts a region of a destination of a target object detected from the video and performs control so as to increase a code amount of the predicted region.

### CITATION LIST

### Patent Literature

Patent Literature 1: Japanese Unexamined Patent Application Publication No. 2021-150739

### SUMMARY OF INVENTION

### Technical Problem

In the related technique as in Patent Literature 1, the region predicted from the detected target object is controlled so that the code amount is always large, that is, the image quality is always high. For this reason, in the related technique, it may be difficult to appropriately suppress the data amount of the video.

In view of such a problem, an object of the present disclosure is to provide a video processing system, a video processing method, and a video processing apparatus capable of appropriately controlling a data amount of a video.

### Solution to Problem

A video processing system according to the present disclosure includes: an image quality control means for controlling image quality of a gaze region including a gaze target in an input video; a recognition means for performing recognition processing regarding an object included in the video in which the image quality of the gaze region is controlled; and an extraction means for extracting the gaze target based on a temporal change in a recognition result of the recognition processing.

A video processing method according to the present disclosure includes: controlling image quality of a gaze region including a gaze target in an input video; performing recognition processing regarding an object included in the video in which the image quality of the gaze region is controlled; and extracting the gaze target based on a temporal change in a recognition result of the recognition processing.

A video processing apparatus according to the present disclosure includes: an image quality control means for controlling image quality of a gaze region including a gaze target in an input video; a recognition means for performing recognition processing regarding an object included in the video in which the image quality of the gaze region is controlled; and an extraction means for extracting the gaze target based on a temporal change in a recognition result of the recognition processing.

### Advantageous Effects of Invention

According to the present disclosure, it is possible to provide a video processing system, a video processing method, and a video processing apparatus capable of appropriately controlling a data amount of a video.

### BRIEF DESCRIPTION OF DRAWINGS

FIG. 1 is a configuration diagram illustrating an outline of a video processing system according to an example embodiment.

FIG. 2 is a configuration diagram illustrating an outline of a video processing apparatus according to the example embodiment.

FIG. 3 is a flowchart illustrating an outline of a video processing method according to the example embodiment.

FIG. 4 is a configuration diagram illustrating a basic configuration of a remote monitoring system according to a first example embodiment.

FIG. 5 is a configuration diagram illustrating a configuration example of a terminal according to a first example embodiment.

FIG. 6 is a configuration diagram illustrating a configuration example of a center server according to the first example embodiment.

FIG. 7 is a configuration diagram illustrating a configuration example of an action recognition unit according to the first example embodiment.

FIG. 8 is a flowchart illustrating an operation example of the remote monitoring system according to the first example embodiment.

FIG. 9 is a diagram for describing video acquisition processing according to the first example embodiment.

FIG. 10 is a diagram for describing object detection processing according to the first example embodiment.

FIG. 11 is a flowchart illustrating an operation example of action recognition processing according to the first example embodiment.

FIG. 12 is a diagram for describing the action recognition processing according to the first example embodiment.

FIG. 13 is a flowchart illustrating an operation example of gaze target extraction processing according to the first example embodiment.

FIG. 14 is a graph for describing gaze target extraction processing according to the first example embodiment.

FIG. 15 is a graph for describing the gaze target extraction processing according to the first example embodiment.

FIG. 16 is a diagram for describing gaze region determination processing according to the first example embodiment.

FIG. 17 is a flowchart illustrating an operation example of gaze target extraction processing according to a second example embodiment.

FIG. 18 is a diagram for describing the gaze target extraction processing according to the second example embodiment.

FIG. 19 is a graph for describing the gaze target extraction processing according to the second example embodiment.

FIG. 20 is a configuration diagram illustrating an outline of hardware of a computer according to the example embodiment.

### EXAMPLE EMBODIMENT

Hereinafter, example embodiments will be described with reference to the drawings. In the drawings, the same elements are denoted by the same reference signs, and redundant description will be omitted as necessary.

In a system that collects a video via a network and recognizes an object, an action, or the like in the video, it is preferable to suppress the data amount of the video to be transmitted as much as possible because the band of the network that transmits the video is limited. For example, the data amount of the video can be suppressed by increasing the compression rate of the video. However, in a case where the video compression rate is high or in a case where the data loss rate is high, erroneous recognition increases, and thus the recognition accuracy decreases. Therefore, in the example embodiments, it is possible to prevent the erroneous recognition while suppressing the data amount of a video to be transmitted as much as possible. For example, erroneous recognition of important events, such as unsafe or dangerous actions is prevented.

### Outline of Example Embodiment

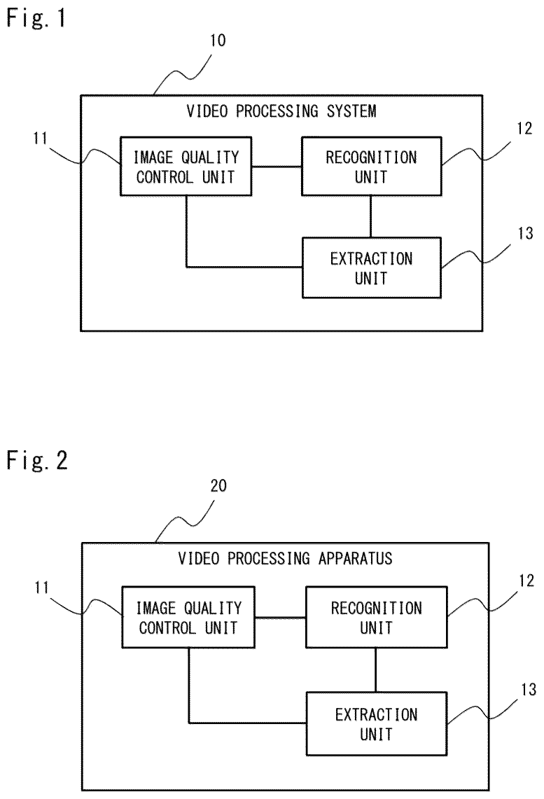

First, an outline of an example embodiment will be described. FIG. 1 illustrates a configuration outline of a video processing system 10 according to the example embodiment. The video processing system 10 can be applied to, for example, a remote monitoring system that collects videos via a network and monitors the videos.

As illustrated in FIG. 1, the video processing system 10 includes an image quality control unit 11, a recognition unit 12, and an extraction unit 13.

The image quality control unit 11 controls the image quality of a gaze region including a gaze target in the input video. For example, the image quality control unit 11 may make the image quality of the gaze region higher, that is, sharper than other regions. The recognition unit 12 performs recognition processing regarding an object included in the video in which the image quality of the gaze region is controlled by the image quality control unit 11. For example, the recognition processing regarding an object is action recognition processing of recognizing an action of an object, but may be processing of recognizing information, features, and the like regarding other objects.

The extraction unit 13 extracts a gaze target based on a temporal change in the recognition result of the recognition processing by the recognition unit 12.

For example, the recognition result includes a score of an action label of the action recognized by the action recognition processing. The action label indicates the type of the recognized action of the object, and the score of the action label indicates the probability that the object is performing the action of the action label. For example, the extraction unit 13 may extract the gaze target based on a temporal increase amount or temporal variation of the score of the action label. The temporal increase amount of the score is an amount by which the score increases with time, and the temporal variation of the score is variation of the score with time. The extraction of a gaze target means selecting a gaze target from among candidates included in the recognition result.

Note that the video processing system 10 may include one apparatus or a plurality of apparatuses. FIG. 2 illustrates a configuration of a video processing apparatus 20 according to the example embodiment. As illustrated in FIG. 2, the video processing apparatus 20 may include the image quality control unit 11, the recognition unit 12, and the extraction unit 13 illustrated in FIG. 1. In addition, the image quality control unit 11, the recognition unit 12, and the extraction unit 13 may be mounted on separate apparatuses. In addition, a part or all of the video processing system 10 may be disposed on an edge or a cloud. For example, in a system that monitors a video captured in a site via a network, an edge is an apparatus disposed at the site or near the site, and is an apparatus close to a terminal in a hierarchy of the network. For example, the image quality control unit 11 may be disposed in an edge terminal, and the recognition unit 12 and the extraction unit 13 may be disposed in a cloud server. Further, functions may be distributed and disposed in the cloud.

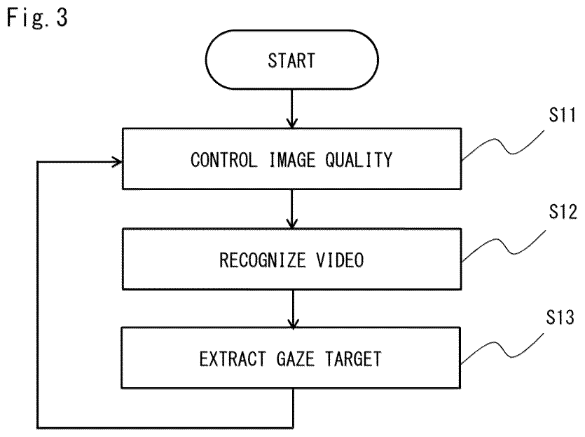

FIG. 3 illustrates a video processing method according to the example embodiment. For example, the video processing method according to the example embodiment is performed by the video processing system 10 in FIG. 1 or the video processing apparatus 20 in FIG. 2. As illustrated in FIG. 3, first, the image quality of a gaze region including a gaze target in the input video is controlled (S11). Next, recognition processing is performed regarding an object included in the video in which the image quality of the gaze region is controlled (S12). Next, a gaze target is extracted based on the temporal change in the recognition result of the recognition processing (S13). Further, the processing returns to S11, and the image quality of the gaze region including the extracted gaze target is controlled on the input video.

As described above, the video processing system according to the example embodiment recognizes an action or the like of an object from a video having controlled image quality, and extracts a gaze target based on a temporal change in the recognition result. For example, in a case where the temporal change in the recognition result is large, there is a high possibility that the object is a target to be gazed at further. Therefore, the target object corresponding to the recognition result is set as the gaze target, so that the region for controlling the image quality can be appropriately selected. In addition, since a region other than the target to be gazed at can be compressed, it is possible to prevent erroneous recognition while suppressing the data amount of the video to be transmitted.

### First Example Embodiment

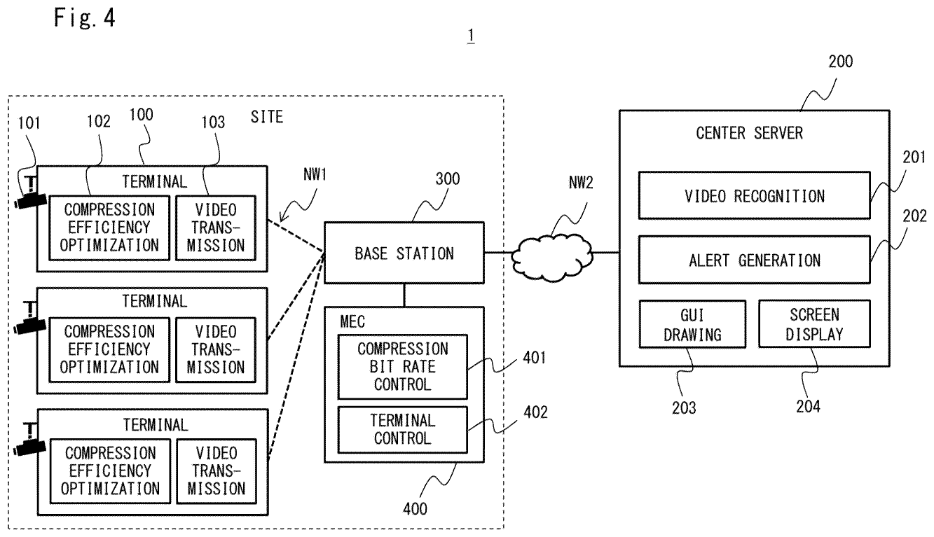

Next, a first example embodiment will be described. Next, a remote monitoring system which is an example of a system to which the present example embodiment is applied will be described. FIG. 4 illustrates a basic configuration of a remote monitoring system 1. The remote monitoring system 1 is a system that monitors a captured area by a video captured by a camera. Hereinafter, the present example embodiment will be described as a system that remotely monitors work of a worker at a site. For example, the site may be an area where people and machines operate, such as a work site such as a construction site, a square where people gather, or a school. In the present example embodiment, hereinafter, the work will be described as construction work, civil engineering work, or the like, but the work is not limited thereto. Note that, since the video includes a plurality of time-series images (also referred to as frames), the video and the image can be paraphrased with each other. That is, the remote monitoring system can be said to be a video processing system that processes a video or an image processing system that processes an image.

As illustrated in FIG. 4, the remote monitoring system 1 includes a plurality of terminals 100, a center server 200, a base station 300, and a MEC 400. The terminal 100, the base station 300, and the MEC 400 are disposed on the site side, and the center server 200 is disposed on the center side. For example, the center server 200 is disposed in a data center, a monitoring center, or the like disposed at a position away from the site. The site side is an edge side of the system, and the center side is also a cloud side. Note that the center server 200 may be configured by one apparatus or a plurality of apparatuses. In addition, a part or all of the center server 200 may be disposed in a cloud. For example, a video recognition function 201 and an alert generation function 202 may be disposed in the cloud, and a GUI drawing function 203 and a screen display function 204 may be disposed in a monitoring center or the like.

The terminal 100 and the base station 300 are communicatively connected by a network NW1. The network NW1 is, for example, a wireless network such as a 4G, local 5G/5G, long term evolution (LTE), or a wireless LAN network. The base station 300 and the center server 200 are communicatively connected by a network NW2. The network NW2 includes, for example, a core network such as a 5th generation core network (5GC) or an evolved packet core (EPC), the Internet, or the like. It can also be said that the terminal 100 and the center server 200 are communicatively connected via the base station 300. The base station 300 and the MEC 400 are communicatively connected by any communication method, and the base station 300 and the MEC 400 may be one apparatus.

The terminal 100 is a terminal apparatus connected to the network NW1, and is also a video generation apparatus that generates a video of the site. The terminal 100 acquires a video captured by the camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 for optimizing compression efficiency and a video transmission function 103. The compression efficiency optimization function 102 performs ROI (region of interest; also referred to as a gaze region) control for controlling the image quality of an ROI. The compression efficiency optimization function 102 reduces the bit rate by reducing the image quality of a region around the ROI including a person or an object, while maintaining the image quality of the ROI. The video transmission function 103 transmits a video having the controlled image quality to the center server 200.

The base station 300 is a base station apparatus for the network NW1, and is also a relay apparatus that relays communication between the terminal 100 and the center server 200. For example, the base station 300 is a local 5G base station, a 5G next generation node B (gNB), an LTE evolved node B (eNB), an access point of a radio LAN, or the like, but may be another relay apparatus.

The multi-access edge computing (MEC) 400 is an edge processing apparatus disposed on the edge side of the system. The MEC 400 is an edge server that controls the terminal 100, and has a compression bit rate control function 401 that controls a bit rate of the terminal and a terminal control function 402. The compression bit rate control function 401 controls a bit rate of the terminal 100 by adaptive video distribution control or quality of experience (QoE) control. For example, the compression bit rate control function 401 predicts the recognition accuracy to be obtained while suppressing the bit rate in accordance with the communication environment of the networks NW1 and NW2, and assigns the bit rate to the camera 101 of each terminal 100 to improve the recognition accuracy. The terminal control function 402 controls the terminal 100 to transmit the video having the assigned bit rate. The terminal 100 encodes the video to have the assigned bit rate, and transmits the encoded video.

The center server 200 is a server installed on the center side of the system. The center server 200 may be one or a plurality of physical servers, a cloud server constructed on a cloud, or another virtualization server. The center server 200 is a monitoring apparatus that monitors work in a site by recognizing the work of a person from a camera video of the site. The center server 200 is also a recognition apparatus that recognizes an action or the like of a person in the video transmitted from the terminal 100.

The center server 200 has the video recognition function 201, the alert generation function 202, the GUI drawing function 203, and the screen display function 204. The video recognition function 201 inputs the video transmitted from the terminal 100 to a video recognition artificial intelligence (AI) engine, thereby recognizing the work performed by a worker, that is, the type of action of the person. The alert generation function 202 generates an alert in accordance with the recognized work. The GUI drawing function 203 displays a graphical user interface (GUI) on a screen of a display device. The screen display function 204 displays a video, a recognition result, an alert, and the like of the terminal 100 on the GUI.

Next, a specific example of a remote monitoring system 1 will be described. In the specific example of the present example embodiment, the gaze target is extracted based on a temporal change in an action recognition result.

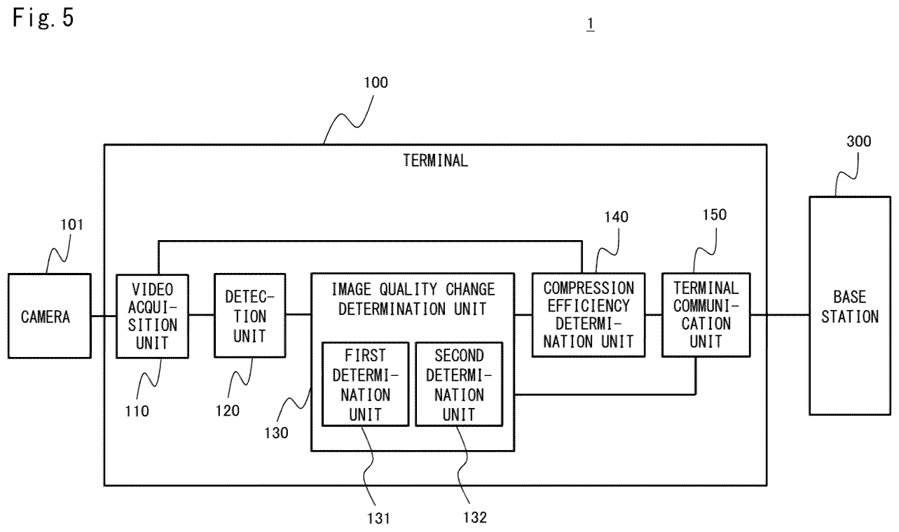

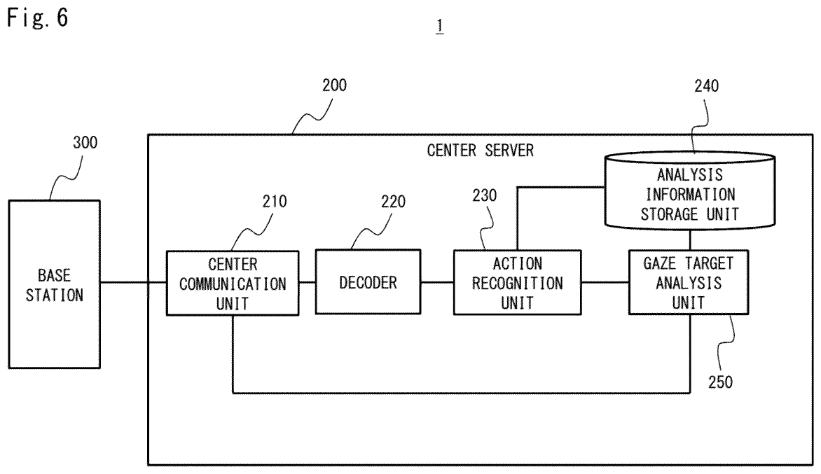

FIG. 5 illustrates a configuration example of the terminal 100 according to the present example embodiment, and FIG. 6 illustrates a configuration example of the center server 200 according to the present example embodiment. Note that the configuration of each apparatus is an example, and another configuration may be used as long as the operation to be described layer according to the present example embodiment can be performed. For example, some functions of the terminal 100 may be disposed in the center server 200 or another apparatus, or some functions of the center server 200 may be disposed in the terminal 100 or another apparatus.

As illustrated in FIG. 5, the terminal 100 includes a video acquisition unit 110, a detection unit 120, an image quality change determination unit 130, a compression efficiency determination unit 140, and a terminal communication unit 150.

The video acquisition unit 110 acquires a video (also referred to as an input video) captured by the camera 101. For example, the input video includes a person who is a worker who performs work on site, a work object used by the person, and the like. The video acquisition unit 110 is also an image acquisition unit that acquires a plurality of time-series images.

The detection unit 120 is an object detection unit that detects an object in the acquired input video. The detection unit 120 detects an object in each image included in the input video, and gives a label of the detected object, that is, an object label. The object label is a class of an object and indicates a type of the object. For example, the object label includes a person, a car, a robot, a hammer, and the like. The detection unit 120 extracts a rectangular region including an object from each image included in the input video, recognizes the object in the extracted rectangular region, and gives a label of the recognized object. The rectangular region is a bounding box or an object region. Note that the object region including the object is not limited to the rectangular region, and may be a region having a circular or amorphous silhouette, or the like. The detection unit 120 calculates a feature amount of an image of the object included in the rectangular region, and recognizes the object based on the calculated feature amount. For example, the detection unit 120 recognizes the object in the image by an object recognition engine using machine learning such as deep learning. The object can be recognized by performing machine learning on the feature of the image of the object and the object label. The detection result of the object includes the object label, position information of the rectangular region including the object, and the like. The position information of the object is, for example, coordinates of each vertex of the rectangular region, and may be a position of the center of the rectangular region or a position of a certain point of the object. The detection unit 120 transmits the detection result of the object to the image quality change determination unit 130.

The image quality change determination unit 130 determines a gaze region (ROI) that is an image quality change region for changing the image quality of the acquired input video. The image quality change determination unit 130 is a determination unit that determines the gaze region. The gaze region is a region including a gaze target, and is a region for improving image quality, that is, improving sharpness. In addition, it can be said that the gaze region is a region that secures the image quality for action recognition.

For example, the image quality change determination unit 130 includes a first determination unit 131 and a second determination unit 132. For example, first, the first determination unit 131 determines a gaze region, and after the center server 200 recognizes an action, the second determination unit 132 determines the gaze region. Note that determination of the gaze region by the first determination unit 131 may be omitted, and only determination of the gaze region by the second determination unit 132 may be performed. The first determination unit 131 determines the gaze region of the input video based on the detection result of the object detected in the input video. The first determination unit 131 determines the gaze region based on the position information of the object having the label, which is a gaze target among detection objects detected in the input video by the detection unit 120. The gaze target may be a person who is a target of action recognition, and may include a work object that may be used by the person in work. For example, the label of the work object is set in advance as a label of an object related to a person. Note that the target of the action recognition is not limited to a person, and may be an object such as heavy machine or a robot. That is, an action including work performed by heavy machine or a robot may be recognized.

In a case where information is fed back from the center server 200 that has recognized the action, the second determination unit 132 determines the gaze region of the input video based on the fed-back information. In this example, extraction gaze target information, which is information of a gaze target extracted by the center server 200, is fed back. The extraction gaze target information is information regarding the gaze target, and is information indicating a gaze target extracted by the center server 200 performing action recognition. The extraction gaze target information is position information of the gaze target and includes position information of a rectangular region of the gaze target. For example, the second determination unit 132 determines the rectangular region indicated by the acquired extraction gaze target information as the gaze region. That is, the region that secures the image quality of the input video is determined based on the extracted position of the gaze target.

The compression efficiency determination unit 140 determines the compression rate of the gaze region or a region other than the gaze region, and compresses the video. The compression efficiency determination unit 140 is an encoder that encodes the input video in accordance with the determined compression rate. The compression efficiency determination unit 140 performs encoding by a moving image encoding method such as H.264 or H.265, for example. In addition, the compression efficiency determination unit 140 encodes the input video to obtain the bit rate assigned from the compression bit rate control function 401 of the MEC 400.

The compression efficiency determination unit 140 is an image quality control unit that controls the image quality of the gaze region determined by the image quality change determination unit 130, and corresponds to the image quality control unit 11 in FIG. 1. In addition, the compression efficiency determination unit 140 can also be said to be an image quality improving unit that improves the image quality of the gaze region. The gaze region is a region determined by either the first determination unit 131 or the second determination unit 132. The compression efficiency determination unit 140 compresses each of the gaze region and the other region at a predetermined compression rate, thereby performing encoding such that the image quality of the gaze region has a predetermined quality. That is, by changing the compression rates of the gaze region and the other region, the gaze region is made higher in image quality than the other region. It can also be said that the image quality of other regions is made lower than the gaze region. For example, the image qualities of the gaze region and the other regions are controlled within a range of the bit rate assigned from the compression bit rate control function 401 of the MEC 400. Note that the image quality of the gaze region may be controlled by changing not only the compression rate but also a resolution, a frame rate, and the like of the image. Furthermore, the image quality of the gaze region may be controlled by changing an information amount of the color of the image, for example, the color, the grayscale, black and white, or the like.

The terminal communication unit 150 transmits the encoded data encoded by the compression efficiency determination unit 140 to the center server 200 via the base station 300. The terminal communication unit 150 is a transmission unit that transmits a video in which the image quality of the gaze region is controlled. In addition, the terminal communication unit 150 receives the extraction gaze target information transmitted from the center server 200 via the base station 300. The terminal communication unit 150 is an acquisition unit that acquires extraction gaze target information. The terminal communication unit 150 is an interface capable of communicating with the base station 300, and is, for example, a radio interface of 4G, local 5G/5G, LTE, a radio LAN, or the like, and may be a radio or wired interface of any other communication scheme. The terminal communication unit 150 may include a first terminal communication unit that transmits encoded data and a second terminal communication unit that receives extraction gaze target information. The first terminal communication unit and the second terminal communication unit may be communication units of the same communication scheme, or may be communication units of different communication schemes.

As illustrated in FIG. 6, the center server 200 includes a center communication unit 210, a decoder 220, an action recognition unit 230, an analysis information storage unit 240, and a gaze target analysis unit 250.

The center communication unit 210 receives encoded data transmitted from the terminal 100 via the base station 300. The center communication unit 210 is a reception unit that receives a video in which the image quality of the gaze region is controlled. In addition, the center communication unit 210 transmits the extraction gaze target information extracted by the gaze target analysis unit 250 to the terminal 100 via the base station 300. The center communication unit 210 is a notification unit that provides notification of extraction gaze target information. The center communication unit 210 is an interface capable of communicating with the Internet or a core network, and is, for example, a wired interface for IP communication, but may be a wired or radio interface of any other communication scheme. The center communication unit 210 may include a first center communication unit that receives encoded data and a second center communication unit that transmits the extraction gaze target information. The first center communication unit and the second center communication unit may be communication units of the same communication scheme, or may be communication units of different communication schemes.

The decoder 220 decodes the encoded data received from the terminal 100. The decoder 220 supports the encoding method of the terminal 100, and performs decoding by a moving image encoding method such as H.264 or H.265, for example. The decoder 220 performs decoding in accordance with the compression rate of each region to generate a decoded video (also referred to as a reception video).

The action recognition unit 230 is a recognition unit that recognizes an action of an object in the decoded reception video, and corresponds to the recognition unit 12 in FIG. 1. The action recognition unit 230 performs action recognition processing of recognizing an action of the gaze target on the video in which the image quality of the gaze region is controlled. The action recognition unit 230 detects an object from the reception video, and recognizes an action of the detected object. The action recognition unit 230 recognizes an action of a person who is a target of action recognition, and gives a label of the recognized action, that is, an action label. The action label is a class of action and indicates a type of action.

For example, the action recognition unit 230 recognizes the action of a person based on the person and a work object detected from the reception video. The action recognition unit 230 may recognize the action of the person by specifying the relevance between the person and the work object. The relevance between the person and the work object includes which object the person is using or whether the person is not using the object. For example, a work object may be specified for each person from a distance between the person and the work object, and an action may be recognized from the specified work object. For example, the action recognition unit 230 performs machine learning on a work object and a work related to a person, and recognizes an action of the person on a machine learning basis. Note that the present invention is not limited to the machine learning basis, the work object and the work related to a person may be associated with each other, and the action of the person may be recognized on the basis of a rule. For example, the work object and work content may be associated in advance, and the action of the person may be recognized based on the detected work object. In addition, in a case where the work object is not detected, the action may be recognized only from the person. For example, the posture or shape of the person and the work content may be associated in advance, and the action of the person may be recognized based on the detected posture or shape of the person.

The analysis information storage unit 240 stores the analysis information analyzed by the action recognition unit 230. The analysis information includes an action recognition result, detection information of a person, detection information of a work object related to an action, and the like. Note that the action recognition result may include the detection information of a person and the detection information of a work object related to an action. The action recognition result includes a label of the recognized action, a score of the action label, identification information of a person who performs the recognized action, identification information of a work object used in the recognized action, and the like. The score of the action label indicates a certainty factor that is the certainty (probability) of the action label. The higher the score, the higher the possibility that the predicted action of the action label is correct. The detection information of the person includes position information of a rectangular region of the person, tracking information, and the like. The tracking information is trajectory information indicating a tracking result of an object. The detection information of the work object includes an object label, a score of the object label, position information of a rectangular region of the object, tracking information, and the like. For example, an action predictor (action recognition engine) of the action recognition unit 230 performs learning such that an object involved in an action is weighted, thereby extracting candidates for a work object, which may be related, for each image, and outputting information of the extracted candidates for the work object. For example, in a case where piling work is recognized, information of a hammer which is an object related to the action is output.

The gaze target analysis unit 250 is an extraction unit that extracts a gaze target based on the analysis information analyzed by the action recognition unit 230, and corresponds to the extraction unit 13 in FIG. 1. The analysis information may be acquired from the action recognition unit 230 or may be acquired from the analysis information storage unit 240. The gaze target analysis unit 250 determines a gaze target for securing image quality in order to prevent an action recognition error, based on the analyzed information. For example, the gaze target analysis unit 250 determines a gaze target based on an action recognition result. The gaze target analysis unit 250 sets, as the gaze target, a person having an action that is recognized by the action recognition unit 230, that is, a person having an action that is included in the action recognition result. In a case where an action is recognized from a person and a related work object, the person and the work object may be set as gaze targets. There may be a plurality of work objects related to a person, and the person and the plurality of work objects may be set as gaze targets. For example, in a case where the piling work is recognized, an object related to the work may be set as “pile” and “hammer”, and a person, “pile”, and “hammer” may be set as gaze targets.

In the present example embodiment, the gaze target analysis unit 250 extracts a gaze target based on the temporal change in the action recognition result. For example, in a case where it is determined based on a temporal increase amount of a score of an action label of interest that the score rises, that is, increases, a person and an object including a work object that has performed the action of the action label may be determined as the gaze targets. In addition, the gaze target may be determined based on a comparison result between the score of the action label and a threshold, or the gaze target may be determined according to temporal variation of the score of the action label.

The gaze target analysis unit 250 outputs the position information of the rectangular region of the extracted gaze target as the extraction gaze target information. The position information is, for example, coordinates of each vertex of the rectangular region, and may be a position of the center of the rectangular region or a position of a certain point of the gaze target. The extraction gaze target information is not limited to the position information as the information regarding the extracted gaze target, and may include information analyzed by the action recognition unit 230, such as a feature of an object label or an image of the gaze target, an action label, and a score of the action label.

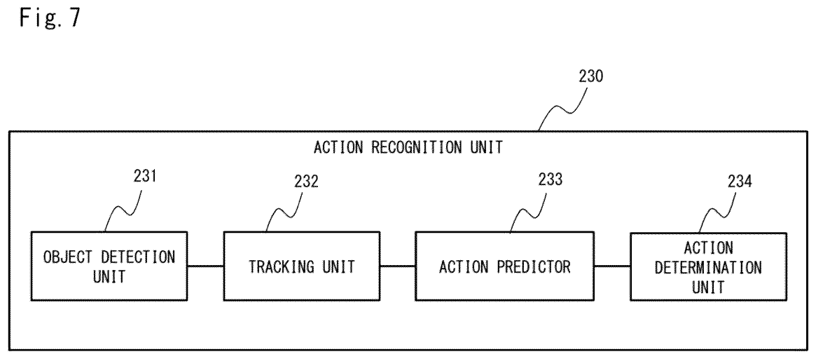

FIG. 7 illustrates a configuration example of the action recognition unit 230 in the center server 200. FIG. 7 is a configuration example in a case where the action recognition with the relevance between the person and the work object is performed on the machine learning basis. In the example of FIG. 7, the action recognition unit 230 includes an object detection unit 231, a tracking unit 232, an action predictor 233, and an action determination unit 234.

The object detection unit 231 detects an object in the input reception video. For example, similarly to the detection unit 120 of the terminal 100, the object detection unit 231 is a detection unit such as an object recognition engine using machine learning. That is, the object detection unit 231 extracts a rectangular region including an object from each image of the reception video, recognizes the object in the extracted rectangular region, and gives a label of the recognized object. The detection result of the object includes the object label and position information of the rectangular region including the object.

The tracking unit 232 tracks the detected object in the reception video. The tracking unit 232 associates the object of each image included in the reception video based on the detection result of the object. By assigning a tracking ID to the detected object, each object can be identified and tracked. For example, an object is tracked by associating objects between images by a distance or overlap (for example, intersection over union (IoU)) between a rectangular region of an object detected in a previous image and a rectangular region of an object detected in the next image.

The action predictor 233 predicts an action of an object for each object tracked by the tracking unit 232. The action predictor 233 recognizes the action of a person tracked in the reception video and gives a label of the recognized action. For example, the action predictor 233 recognizes the action of the person in the reception video by the action recognition engine using machine learning such as deep learning. The action of the person can be recognized by performing machine learning on the video of the person who performs the work using the work object and the action label. For example, machine learning is performed by using learning data that is a video of a person who is working using a work object, annotation information such as positions of the person and the work object and related information between the person and the object, and action information such as a work object necessary for each work. In addition, the action predictor 233 outputs the score of the recognized action label.

The action determination unit 234 determines an action of an object based on the predicted action label. The action determination unit 234 determines the action of the person based on the score of the action label predicted by the action predictor 233. For example, the action determination unit 234 outputs an action label having the highest score, as a recognition result.

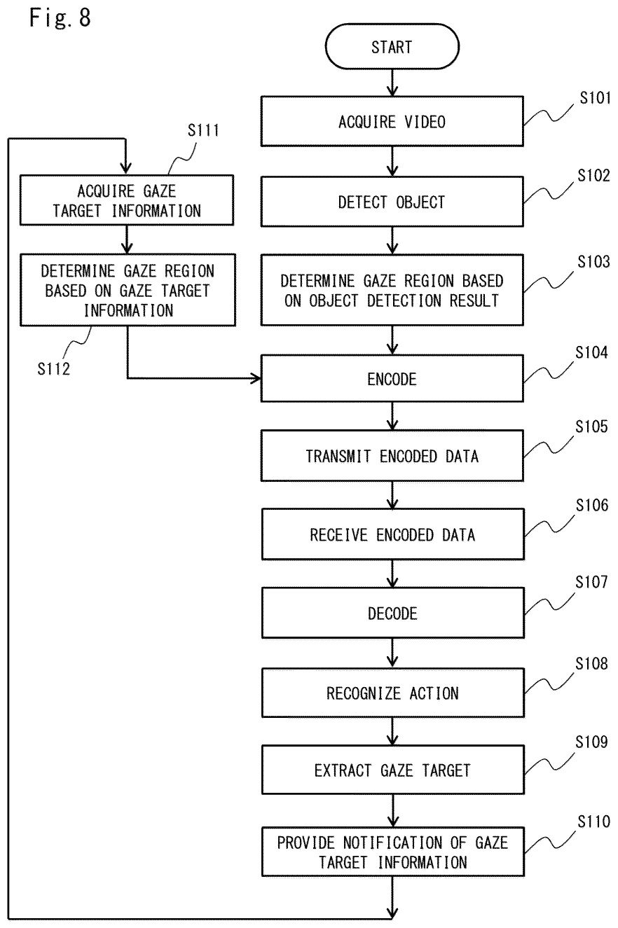

Next, an operation of the remote monitoring system according to the present example embodiment will be described. FIG. 8 illustrates an operation example of the remote monitoring system 1. For example, description will be made on the assumption that the terminal 100 executes S101 to S105 and S111 and S112, and the center server 200 executes S106 to S110, but the present example embodiment is not limited thereto, and any apparatus may execute each process.

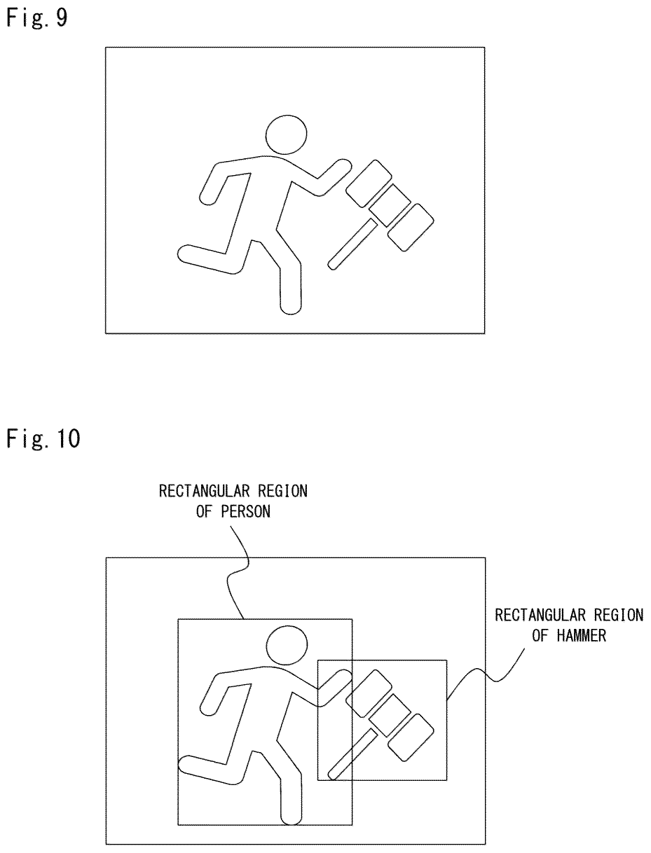

As illustrated in FIG. 8, the terminal 100 acquires a video from the camera 101 (S101). The camera 101 generates a video obtained by imaging the site, and the video acquisition unit 110 acquires a video (input video) output from the camera 101. For example, as illustrated in FIG. 9, the image of the input video includes a person who performs work on site and a work object such as a hammer used by the person.

Subsequently, the terminal 100 detects an object based on the acquired input video (S102). The detection unit 120 detects a rectangular region in an image included in the input video using the object recognition engine, recognizes an object in the detected rectangular region, and gives a label of the recognized object. For each detected object, the detection unit 120 outputs an object label and position information of a rectangular region of the object as the object detection result. For example, in a case where object detection is performed from the image of FIG. 9, a person and a hammer are detected, and a rectangular region of the person and a rectangular region of the hammer are detected as illustrated in FIG. 10.

Subsequently, the terminal 100 determines a gaze region in the input video based on the object detection result (S103). The first determination unit 131 of the image quality change determination unit 130 extracts an object having a label as a gaze target, based on the object detection result of each object. The first determination unit 131 extracts an object having an object label that is a person or a work object from the detected object, and determines a rectangular region of the extracted object as a gaze region. In the example of FIG. 10, a person and a hammer are detected in the image, and since the hammer corresponds to a work object, a rectangular region of the person and a rectangular region of the hammer are determined as gaze regions.

Subsequently, the terminal 100 encodes the input video based on the determined gaze region (S104). The compression efficiency determination unit 140 encodes the input video such that the gaze region has higher image quality than other regions. In the example of FIG. 10, the compression rates of the rectangular region of the person and the rectangular region of the hammer are made lower than the compression rates of the other regions, thereby improving the image quality of the rectangular region of the person and the rectangular region of the hammer.

Subsequently, the terminal 100 transmits the encoded data to the center server 200 (S105), and the center server 200 receives the encoded data (S106). The terminal communication unit 150 transmits encoded data obtained by improving the image quality of the gaze region to the base station 300. The base station 300 transfers the received encoded data to the center server 200 via the core network or the Internet. The center communication unit 210 receives the transferred encoded data from the base station 300.

Subsequently, the center server 200 decodes the received encoded data (S107). The decoder 220 decodes the encoded data in accordance with the compression rate of each region, and generates a video (reception video) in which the gaze region is improved in image quality.

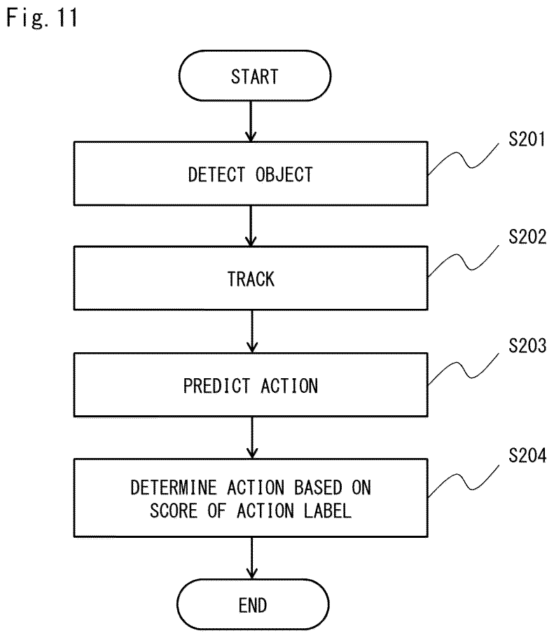

Subsequently, the center server 200 recognizes an action of an object based on the decoded reception video (S108). FIG. 11 illustrates an example of action recognition processing by the action recognition unit 230 illustrated in FIG. 7.

In the example of FIG. 11, first, the object detection unit 231 detects an object in the input reception video (S201). The object detection unit 231 detects a rectangular region in each image included in the reception video using the object recognition engine, recognizes an object in the detected rectangular region, and gives a label of the recognized object. For each detected object, the object detection unit 231 outputs an object label and position information of the rectangular region of the object as the object detection result.

Subsequently, the tracking unit 232 tracks the detected object in the reception video (S202). The tracking unit 232 assigns a tracking ID to each detected object, and tracks the object identified by the tracking ID with each image.

Subsequently, the action predictor 233 predicts an action of an object for each tracked object (S203). The action predictor 233 predicts an action of a person from a video including the tracked person and a work object by using the action recognition engine. The action predictor 233 outputs a label of the predicted action and a score of each action label.

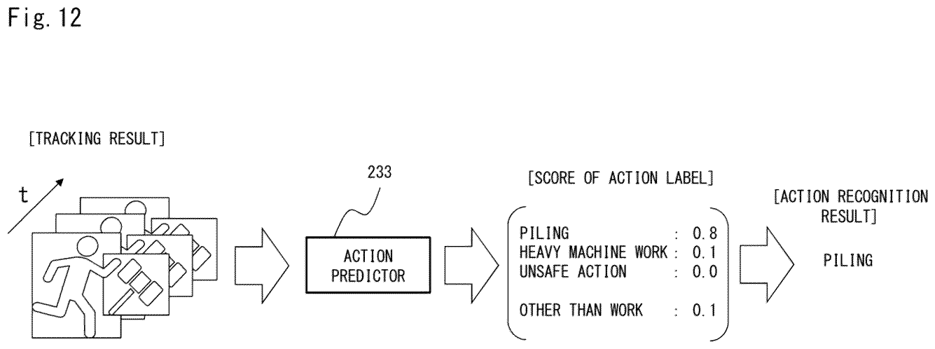

Subsequently, the action determination unit 234 determines the action of the object based on the score of the predicted action label (S204). In the example of FIG. 12, a person and a hammer are detected by tracking. The action predictor 233 recognizes the action of the person based on the video of the detected person and hammer, and outputs the score of each action label. For example, the score of piling is 0.8, the score of heavy machine work is 0.1, the score of an unsafe action is 0.0, and the score of non-work is 0.1. Then, the action determination unit 234 determines that the action of the person is piling because the score of piling is the highest. The action determination unit 234 outputs the determined action and the score of the action.

Returning to FIG. 8, following the action recognition processing, the center server 200 extracts a gaze target based on the analysis information analyzed by the action recognition processing (S109). The gaze target analysis unit 250 may set a person having the recognized action as the gaze target, and further include a work object as the gaze target in a case where the recognition target includes the work object. For example, in the example of FIG. 12, since work of piling is recognized from a person and a hammer, the person having recognized the work and the hammer may be set as the gaze targets. The gaze target analysis unit 250 outputs gaze target extraction information including the position information of the extracted gaze target.

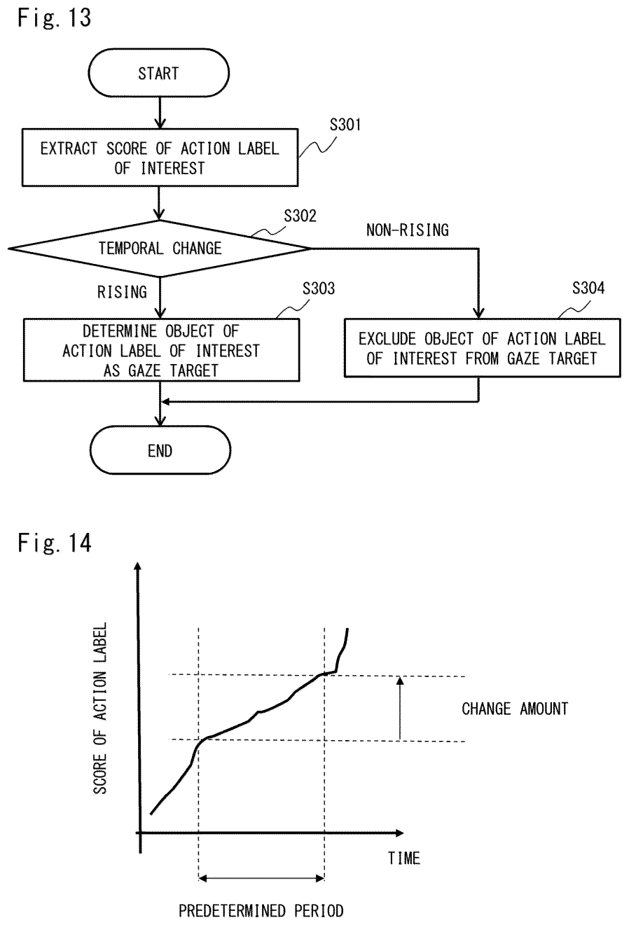

In the present example embodiment, the gaze target is extracted based on the temporal change in the action recognition result. FIG. 13 illustrates an operation example of gaze target extraction processing according to the present example embodiment. In a case where actions of a plurality of objects are recognized, the gaze target extraction processing is performed on a recognition result of each object. In the example of FIG. 13, first, the gaze target analysis unit 250 extracts a score of an action label of interest (S301). The action label of interest is an action label of an action that a user wants to focus on among action labels of recognizable actions. For example, the action label of interest is set in advance, and the gaze target analysis unit 250 extracts a score of the set action label from the action recognition results. For example, a score of a corresponding action label is extracted from among scores of a plurality of action labels generated by the action predictor 233. In a case where there is a plurality of action labels of interest, scores of the plurality of corresponding action labels of interest may be extracted from the action recognition results. Note that not only the action label of interest but also a score of an arbitrary action label, for example, the highest score may be extracted from the scores of the plurality of action labels included in the action recognition results.

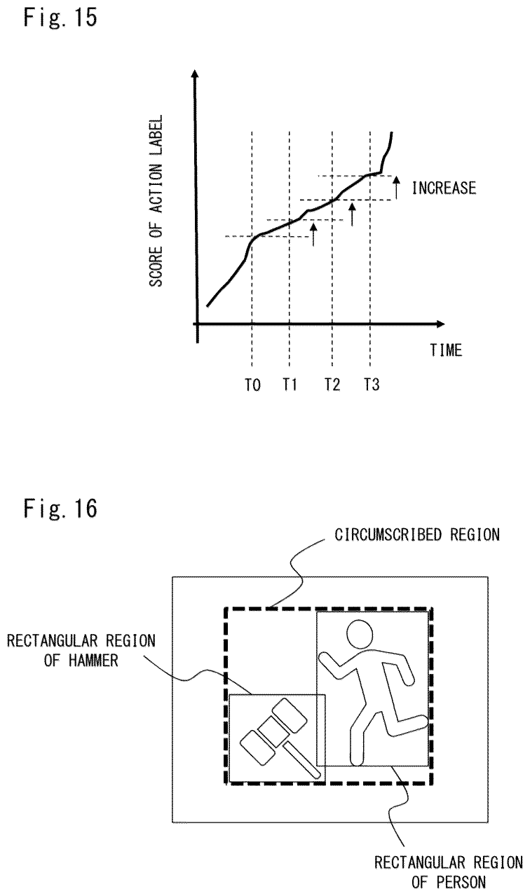

Subsequently, the gaze target analysis unit 250 determines a temporal change in the score of the action label of interest (S302). For example, based on the temporal change in the score of the action label of interest, the gaze target analysis unit 250 determines whether the score is increasing, that is, whether the score tends to rise. For example, as illustrated in FIG. 14, it may be determined whether the change amount of the score of the action label in a predetermined period, that is, the rate of rise is larger than a predetermined threshold. In addition, as illustrated in FIG. 15, it may be determined whether the score of the action label continuously increases at a plurality of times (for example, T0 to T3) from the previous time.

In addition, the gaze target analysis unit 250 may determine whether the score of the action label of interest is larger than a predetermined threshold. For example, the scores of the action label at a plurality of times are compared with the threshold. The threshold may be set for each action label. For example, it may be determined whether the score at each time continuously exceeds the threshold, or it may be determined the number of times the score at each time exceeds the threshold.

In addition, the gaze target analysis unit 250 may determine whether the variation in the score of the action label of interest is large. For example, it is determined whether the variation in the scores of the action label at a plurality of times is within a predetermined range.

If it is determined based on the temporal change in the score of the action label of interest that the score rises, the gaze target analysis unit 250 determines, as the gaze target, a target object that performs the action of the action label of interest (S303). In the example of FIG. 14, in a case where the score increases three times in one minute of the predetermined period, it is determined that the score tends to rise, and the target object of the corresponding action label is determined as the gaze target. In the example of FIG. 15, in a case where the score continuously increases at 3 points/s of T1 to T3, it is determined that the score tends to rise, and the target object of the corresponding action label is determined as the gaze target. In a case where the score of the action label tends to rise, there is an increasing possibility that the action label is an action to be more focused on, so that it is possible to determine an object of the action label as the gaze target and to accurately recognize the action of the corresponding object by a video with improved image quality.

In addition, if it is determined that the score of the action label of interest is larger than the threshold, the gaze target analysis unit 250 may determine the target object of the action label of interest as the gaze target. For example, in a case where the score is continuously larger than the threshold at 3 points/s, it is determined that a state where the score is large continues, and the target object of the corresponding action label is determined as the gaze target. In a case where a state where the score of the action label is large continues, there is a high possibility that an action to be more focused on is continuously performed, so that it is possible to determine an object of the action label as the gaze target and to accurately recognize the action of the corresponding object by a video with improved image quality.

In addition, if it is determined that the variation in the score of the action label of interest is large, the gaze target analysis unit 250 may determine the target object of the action label of interest as the gaze target. For example, in a case where the score is 0.1 at the time T=1, the score is 0.8 at the time T=2, the score is 0.2 at the time T=3, and the score is 0.9 at the time T=4, the change in the score with time is great, so that it is determined that the variation is large, and the target object of the corresponding action label is determined as the gaze target. In addition, the variation may be measured by using the variance of the scores of the action labels in the recognition results obtained a plurality of times in the past, and in a case where the variance exceeds a predefined threshold, it may be determined that the variation is large, and the target object of the corresponding action label may be determined as the gaze target. In a case where the score of the action label varies, there is a high possibility that the action label has not been correctly determined, so that it is possible to determine an object of the action label as the gaze target and to correctly determine the action of the corresponding object by a video with improved image quality.

On the other hand, if it is determined based on the temporal change in the score of the action label of interest that the score has not risen, the gaze target analysis unit 250 excludes, from the gaze target, the target object that performs the action of the action label of interest (S304). That is, in this case, the gaze target analysis unit 250 does not select the object as the gaze target. In the example of FIG. 14, in a case where the score increases less than two times in one minute of the predetermined period, it is determined that the score does not tend to rise, and the target object of the corresponding action label is excluded from the gaze target. In addition, in the example of FIG. 15, in a case where the score decreases even at one point among 3 points/s of T1 to T3, it is determined that the score does not tend to rise, and the target object of the corresponding action label is excluded from the gaze

In addition, if it is determined that the score of the action label of interest is smaller than the threshold, the gaze target analysis unit 250 may exclude the target object of the action label of interest from the gaze target. For example, in a case where the score falls below the threshold even at one point of 3 points/s, it is determined that a state in which the score is high has not continued, and the target object of the corresponding action label is excluded from the gaze target.

In addition, if it is determined that the variation in the score of the action label of interest is small, the gaze target analysis unit 250 may exclude the target object of the action label of interest from the gaze target. For example, in a case where the score is 0.7 at the time T=1, the score is 0.8 at the time T=2, the score is 0.8 at the time T=3, and the score is 0.9 at the time T=4, the change in the score with time is small, so that it is determined that the variation is small, and the target object of the corresponding action label is excluded from the gaze target. In addition, the variation may be measured by using the variance of the scores of the action labels in the recognition results obtained a plurality of times in the past, and in a case where the variance is smaller than the predefined threshold, it may be determined that the variation is small, and the target object of the corresponding action label may be excluded from the gaze target.

Returning to FIG. 8, following the gaze target extraction processing, the center server 200 notifies the terminal 100 of the extraction gaze target information extracted in the gaze target extraction processing (S110), and the terminal 100 acquires the extraction gaze target information (S111). The center communication unit 210 transmits the extraction gaze target information indicating the position of the extracted gaze target to the base station 300 via the Internet or the core network. The base station 300 transfers the received extraction gaze target information to the terminal 100. The terminal communication unit 150 receives the transferred extraction gaze target information from the base station 300.

Subsequently, the terminal 100 determines the gaze region based on the received extraction gaze target information (S112). The second determination unit 132 of the image quality change determination unit 130 determines a region indicated by the extraction gaze target information notification of which is provided from the center server 200 as the gaze region. In the example of FIG. 16, the extraction gaze target information indicates a rectangular region of a person and a rectangular region of a hammer, and these regions are determined as the gaze regions. In addition, a circumscribed region including the rectangular region of the person and the rectangular region of the hammer may be set as the gaze region. Notification of the circumscribed region may be provided from the center server 200 to the terminal 100. Thereafter, S104 to S112 are repeated.

As described above, in the present example embodiment, in the system that recognizes the action of the object from the video, the gaze target is extracted based on the temporal change in the action recognition result, and the image quality of the region including the extracted gaze target is improved. For example, it is assumed that in a case where the action recognition result rises in time or varies in time, there is a high need to recognize the action of the object.

Therefore, by making a determination based on the temporal change in the action recognition result, it is possible to appropriately select a target to be gazed at.

Therefore, according to the action recognition result, the image quality of a specific portion including the target to be gazed at is secured, and the other regions can be compressed, so that an action recognition error can be prevented while the amount of data to be transmitted is suppressed.

### Second Example Embodiment

Next, a second example embodiment will be described. In the present example embodiment, an example will be described in which an extraction target is extracted based on a positional relationship of an object included in the action recognition result. The configuration of the remote monitoring system according to the present example embodiment is similar to the configuration of the remote monitoring system in FIGS. 5 and 6 according to the first example embodiment, and thus description thereof will be omitted. Note that the present example embodiment can be implemented in combination with the first example embodiment, and each component described in the first example embodiment may be appropriately used.

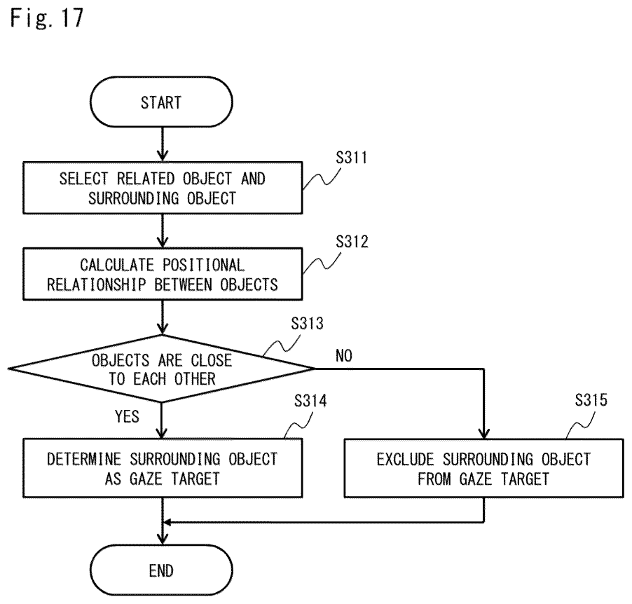

In the present example embodiment, an overall operation flow of the remote monitoring system is similar to that in FIG. 8 of the first example embodiment, and only gaze target extraction processing (S109) is different from that in the first example embodiment. FIG. 17 illustrates an operation example of gaze target extraction processing according to the present example embodiment.

Note that the gaze target may be extracted by either the gaze target extraction processing of the first example embodiment or the gaze target extraction processing of the present example embodiment, or the gaze target may be extracted by both the gaze target extraction processing of the first example embodiment and the gaze target extraction processing of the present example embodiment.

In the example of FIG. 17, first, the gaze target analysis unit 250 selects a related object and a surrounding object related to an action to be determined (S311). The related object related to the action to be determined is a related object related to the action to be determined by the user among recognizable actions. The related object is a work object used by a person in work. For example, the object label of the related object related to the action to be determined is set in advance, and in a case where the object label of the object included in the action recognition result corresponds to the set object label, the gaze target analysis unit 250 selects, as the related object, the object included in the action recognition result.

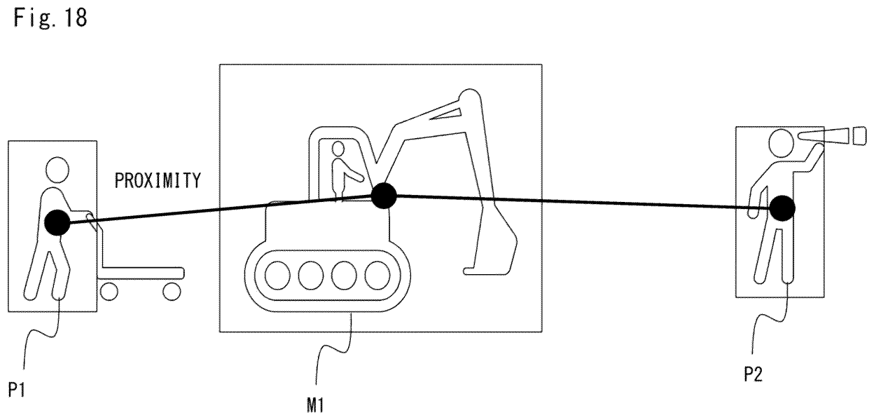

Moreover, the gaze target analysis unit 250 selects surrounding objects around the related object in the video in which the action recognition has been performed. All objects other than the related object detected from the video by the object detection may be selected as the surrounding objects, or objects detected within a predetermined range around the related object in the image may be selected as the surrounding objects. The surrounding object may be an object having a specific object label, or may be any object. For example, an object label of an object to be the surrounding object may be set in advance, and an object having the set object label may be selected as the surrounding object. In the example of FIG. 18, in a case where an intention is to determine approach to the heavy machine as an unsafe action, heavy machine M1 related to the approach of the heavy machine is selected as the related object from the action recognition result, and persons P1 and P2 around the heavy machine M1 are selected as the surrounding objects.

Subsequently, the gaze target analysis unit 250 calculates a positional relationship between the selected related object and surrounding objects (S312). The gaze target analysis unit 250 calculates an index of proximity on the image as the positional relationship between the related object and the surrounding objects. Examples of the index of the proximity on the image include a Euclidean distance of the center of the rectangular region of the object, an average of Euclidean distances of the squares of the rectangular region of the object, and an overlapping degree (IoU) of the rectangles of the objects. In a case where a plurality of surrounding objects are selected, an index of the proximity between the related object and each surrounding object is calculated. In the example of FIG. 18, the Euclidean distance between the center of the rectangular region of the heavy machine Ml and the center of the rectangular region of the person Pl is calculated, and the Euclidean distance between the center of the rectangular region of the heavy machine M1 and the center of the rectangular region of the person P2 is calculated.

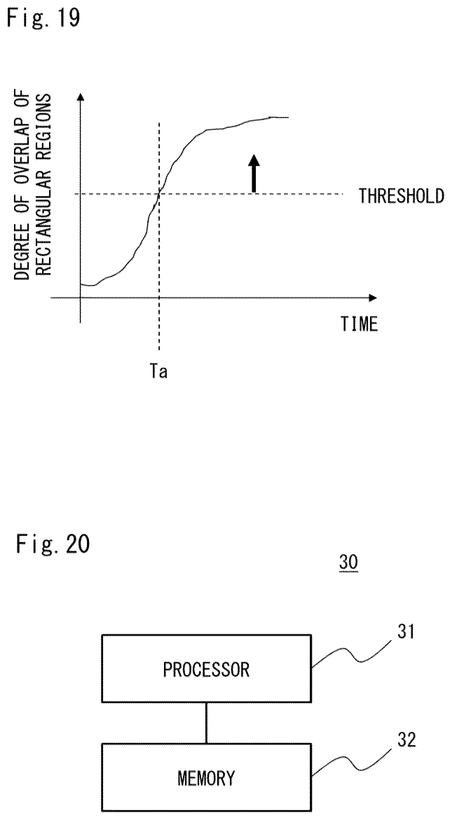

Subsequently, the gaze target analysis unit 250 determines whether the related object and the surrounding object are close to each other based on the calculated positional relationship (S313), and determines the surrounding object as the gaze target if it is determined that the related object and the surrounding object are close to each other (S314). For example, in a case where the index of the proximity satisfies a certain threshold or in a case where a temporal change in the index of the proximity exceeds a certain threshold, the surrounding object is determined as the gaze target. In a case where the Euclidean distance between the objects is smaller than a threshold or in a case where the degree of overlap between the objects is larger than a threshold, the surrounding object may be determined as the gaze target. In the example of FIG. 18, in a case where the Euclidean distance between the center of the rectangular region of the heavy machine M1 and the center of the rectangular region of the person P1 is smaller than the threshold, the person Pl is determined to be the gaze target. In addition, in the example of FIG. 19, in a case after the time Ta, the degree of overlap of the rectangular regions exceeds the threshold, and thus the surrounding object is determined as the gaze target. Note that the gaze target may be determined according to a temporal change in the positional relationship between the related object and the surrounding object. For example, in a case where a distance between the related object and the surrounding object gradually decreases or in a case where the distance is smaller than a threshold, the surrounding object may be determined as the gaze target. In a case where overlap between the region of the related object and the region of the surrounding object gradually increases or in a case where the overlap increases more than a threshold, the surrounding object may be determined as the gaze target. In addition, the gaze target may be determined not only based on the positional relationship between the related object and the surrounding objects but also based on the directions of the related object and the surrounding objects. For example, in a case where the direction of the person who is the surrounding object is directed to the related object, the surrounding object may be determined as the gaze target.

In addition, in a case where it is determined that the related object and the surrounding object are separated, the gaze target analysis unit 250 excludes the surrounding object from the gaze target (S315). That is, the surrounding object is not selected as the gaze target. For example, in a case where the index of the proximity does not satisfy the certain threshold or in a case where the temporal change of the index of the proximity does not exceed the certain threshold, the surrounding object is excluded from the gaze target. In a case where the Euclidean distance between the objects is larger than the threshold or in a case where the degree of overlap between the objects is smaller than the threshold, the surrounding objects may be excluded from the gaze target. In the example of FIG. 18, in a case where the Euclidean distance between the center of the rectangular region of the heavy machine M1 and the center of the rectangular region of the person P2 is larger than the threshold, the person P2 is excluded from the gaze target. In addition, in the example of FIG. 19, in a case before the time Ta, the degree of overlap of the rectangular regions is smaller than the threshold, and thus, the surrounding object is not selected as the gaze target.

As described above, the gaze target may be determined based on the positional relationship between the related object related to the action and the surrounding object to be determined. Accordingly, for example, in the case of a dangerous state such as an unsafe action, a person performing a dangerous action can be set as the gaze target. Therefore, the image quality of the region including the person can be secured, and the action such as the unsafe action can be accurately recognized.

Note that the present disclosure is not limited to the above-described example embodiments, and can be appropriately modified without departing from the scope. For example, in the above example embodiments, the center server extracts the gaze target, and the terminal determines the gaze region based on the extracted gaze target. However, the center server may determine the gaze region based on the extracted gaze target. In this case, the center server may notify the terminal of the coordinates of the gaze region and the size of the region.

In addition, the processing flow described in the above example embodiments is an example, and the order of each processing is not limited to the above example. The order of part of the processing may be changed and executed, or part of the processing may be executed in parallel.

Each configuration in the above-described example embodiments may be implemented by hardware, software, or both, and may be implemented by one piece of hardware or software or by a plurality of pieces of hardware or software. The apparatuses and functions (processing) may be realized by a computer 30 including a processor 31, such as a central processing unit (CPU), and a memory 32, which is a storage device, as illustrated in FIG. 20. For example, programs for performing the methods (video processing methods) in the example embodiments may be stored in the memory 32, and the functions may be realized by the processor 31 executing the programs stored in the memory 32.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, the transitory computer readable medium or communication medium include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following supplementary notes, but are not limited to the following supplementary notes.

### Supplementary Note 1

A video processing system including:
an image quality control means for controlling image quality of a gaze region including a gaze target in an input video;
a recognition means for performing recognition processing regarding an object included in the video in which the image quality of the gaze region is controlled; and
an extraction means for extracting the gaze target based on a temporal change in a recognition result of the recognition processing.

### Supplementary Note 2

The video processing system according to supplementary note 1, in which
the recognition processing includes processing of recognizing an action of the object, and
the extraction means extracts the gaze target based on a temporal change in a score of an action label included in the recognition result.

### Supplementary Note 3

The video processing system according to supplementary note 2, in which the extraction means extracts the gaze target based on a temporal increase amount of the score of the action label.

### Supplementary Note 4

The video processing system according to supplementary note 2, in which the extraction means extracts the gaze target based on temporal variation in the score of the action label.

### Supplementary Note 5

The video processing system according to any one of supplementary notes 2 to 4, in which the extraction means extracts the gaze target based on a positional relationship between a related object related to the recognized action and another object.

### Supplementary Note 6

The video processing system according to supplementary note 5, in which the extraction means determines the another object as the gaze target in a case where a distance between the related object and the another object is smaller than a predetermined threshold.

### Supplementary Note 7

The video processing system according to supplementary note 5, in which the extraction means determines the another object as the gaze target in a case where overlap between a region including the related object and a region including the another object is larger than a predetermined threshold.

### Supplementary Note 8

A video processing method including:
controlling image quality of a gaze region including a gaze target in an input video;
performing recognition processing regarding an object included in the video in which the image quality of the gaze region is controlled; and
extracting the gaze target based on a temporal change in a recognition result of the recognition processing.

### Supplementary Note 9

The video processing method according to supplementary note 8, in which
the recognition processing includes processing of recognizing an action of the object, and
the gaze target is extracted based on a temporal change in a score of an action label included in the recognition result.

### Supplementary Note 10

The video processing method according to supplementary note 9, in which the gaze target is extracted based on a temporal increase amount of the score of the action label.

### Supplementary Note 11

The video processing method according to supplementary note 9, in which the gaze target is extracted based on temporal variation in the score of the action label.

### Supplementary Note 12

The video processing method according to any one of supplementary notes to 11, in which the gaze target is extracted based on a positional relationship between a related object related to the recognized action and another object.

### Supplementary Note 13

The video processing method according to supplementary note 12, in which the another object is determined as the gaze target in a case where a distance between the related object and the another object is smaller than a predetermined threshold.

### Supplementary Note 14

The video processing method according to supplementary note 12, in which the another object is determined as the gaze target in a case where overlap between a region including the related object and a region including the another object is larger than a predetermined threshold.

### Supplementary Note 15

A video processing apparatus including:
an image quality control means for controlling image quality of a gaze region including a gaze target in an input video;
a recognition means for performing recognition processing regarding an object included in the video in which the image quality of the gaze region is controlled; and
an extraction means for extracting the gaze target based on a temporal change in a recognition result of the recognition processing.

### Supplementary Note 16

The video processing apparatus according to supplementary note 15, in which
the recognition processing includes processing of recognizing an action of the object, and
the extraction means extracts the gaze target based on a temporal change in a score of an action label included in the recognition result.

### Supplementary Note 17

The video processing apparatus according to supplementary note 16, in which the extraction means extracts the gaze target based on a temporal increase amount of the score of the action label.

### Supplementary Note 18

The video processing apparatus according to supplementary note 16, in which the extraction means extracts the gaze target based on a temporal variation in the score of the action label.

### Supplementary Note 19

The video processing apparatus according to any one of supplementary notes 16 to 18, in which the extraction means extracts the gaze target based on a positional relationship between a related object related to the recognized action and another object.

### Supplementary Note 20

The video processing apparatus according to supplementary note 19, in which the extraction means determines the another object as the gaze target in a case where a distance between the related object and the another object is smaller than a predetermined threshold or in a case where overlap between a region including the related object and a region including the another object is larger than a predetermined threshold.

### REFERENCE SIGNS LIST

1 REMOTE MONITORING SYSTEM
10 VIDEO PROCESSING SYSTEM
11 IMAGE QUALITY CONTROL UNIT
12 RECOGNITION UNIT
13 EXTRACTION UNIT
20 VIDEO PROCESSING APPARATUS
30 COMPUTER
31 PROCESSOR
32 MEMORY
100 TERMINAL
101 CAMERA
102 COMPRESSION EFFICIENCY OPTIMIZATION FUNCTION
103 VIDEO TRANSMISSION FUNCTION
110 VIDEO ACQUISITION UNIT
120 DETECTION UNIT
130 IMAGE QUALITY CHANGE DETERMINATION UNIT
131 FIRST DETERMINATION UNIT
132 SECOND DETERMINATION UNIT
140 COMPRESSION EFFICIENCY DETERMINATION UNIT
150 TERMINAL COMMUNICATION UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 CENTER COMMUNICATION UNIT
220 DECODER
230 ACTION RECOGNITION UNIT
231 OBJECT DETECTION UNIT
232 TRACKING UNIT
233 ACTION PREDICTOR
234 ACTION DETERMINATION UNIT
240 ANALYSIS INFORMATION STORAGE UNIT
300 BASE STATION
400 MEC
401 COMPRESSION BIT RATE CONTROL FUNCTION
402 TERMINAL CONTROL FUNCTION

What is claimed is:

1. A video processing system comprising:
a memory configured to store instructions, and
a processor configured to execute the instructions to;
control image quality of a gaze region including a gaze target in an input video;
perform recognition processing regarding an object included in the video in which the image quality of the gaze region is controlled; and
extract the gaze target based on a temporal change in a recognition result of the recognition processing.

2. The video processing system according to claim 1, wherein
the recognition processing includes processing of recognizing an action of the object, and
the processor is further configured to execute the instructions to extract the gaze target based on a temporal change in a score of an action label included in the recognition result.

3. The video processing system according to claim 2, wherein the processor is further configured to execute the instructions to extract the gaze target based on a temporal increase amount of the score of the action label.

4. The video processing system according to claim 2, wherein the processor is further configured to execute the instructions to extract the gaze target based on temporal variation in the score of the action label.

5. The video processing system according to claim 2, wherein the processor is further configured to execute the instructions to extract the gaze target based on a positional relationship between a related object related to the recognized action and another object.

6. The video processing system according to claim 5, wherein the processor is further configured to execute the instructions to determine the another object as the gaze target in a case where a distance between the related object and the another object is smaller than a predetermined threshold.

7. The video processing system according to claim 5, wherein the processor is further configured to execute the instructions to determine the another object as the gaze target in a case where overlap between a region including the related object and a region including the another object is larger than a predetermined threshold.

8. A video processing method comprising:
controlling image quality of a gaze region including a gaze target in an input video;
performing recognition processing regarding an object included in the video in which the image quality of the gaze region is controlled; and
extracting the gaze target based on a temporal change in a recognition result of the recognition processing.

9. The video processing method according to claim 8, wherein
the recognition processing includes processing of recognizing an action of the object, and
the gaze target is extracted based on a temporal change in a score of an action label included in the recognition result.

10. The video processing method according to claim 9, wherein the gaze target is extracted based on a temporal increase amount of the score of the action label.

11. The video processing method according to claim 9, wherein the gaze target is extracted based on temporal variation in the score of the action label.

12. The video processing method according to claim wherein the gaze target is extracted based on a positional relationship between a related object related to the recognized action and another object.

13. The video processing method according to claim 12, wherein the another object is determined as the gaze target in a case where a distance between the related object and the another object is smaller than a predetermined threshold.

14. The video processing method according to claim 12, wherein the another object is determined as the gaze target in a case where overlap between a region including the related object and a region including the another object is larger than a predetermined threshold.

15. A video processing apparatus comprising:
a memory configured to store instructions, and
a processor configured to execute the instructions to;
an control image quality of a gaze region including a gaze target in an input video;
perform recognition processing regarding an object included in the video in which the image quality of the gaze region is controlled; and
extract the gaze target based on a temporal change in a recognition result of the recognition processing.

16. The video processing apparatus according to claim 15, wherein the recognition processing includes processing of recognizing an action of the object, and
the processor is further configured to execute the instructions to extract the gaze target based on a temporal change in a score of an action label included in the recognition result.

17. The video processing apparatus according to claim 16, wherein the processor is further configured to execute the instructions to extract the gaze target based on a temporal increase amount of the score of the action label.

18. The video processing apparatus according to claim 16, wherein the processor is further configured to execute the instructions to extract the gaze target based on a temporal variation in the score of the action label.

19. The video processing apparatus according to claim 16, wherein the processor is further configured to execute the instructions to extract the gaze target based on a positional relationship between a related object related to the recognized action and another object.

20. The video processing apparatus according to claim 19, wherein the processor is further configured to execute the instructions to determine the another object as the gaze target in a case where a distance between the related object and the another object is smaller than a predetermined threshold or in a case where overlap between a region including the related object and a region including the another object is larger than a predetermined threshold.
